(19) United States
(12) Patent Application Publication
(10) Pub. No.: US 2023/0194950 A1
(43) Pub. Date: Jun. 22, 2023

(54) LIGHT-GUIDING DEVICE AND OPTICAL RADAR

(71) Applicant: HON HAI PRECISION INDUSTRY CO., LTD., New Taipei (TW)

(72) Inventors: YUNG-CHANG TSENG, New Taipei (TW); KUO-FONG TSENG, Tu-Cheng (TW)

(21) Appl. No.: 17/856,069

(22) Filed: Jul. 1, 2022

(30) Foreign Application Priority Data
Dec. 20, 2021 (CN) 202111564097.5

(51) Int. Cl. G02F 1/295; G01S 7/481; G01S 17/42

(52) U.S. Cl. CPC G02F 1/295; G01S 7/4814; G01S 17/42

(57) ABSTRACT

A non-mechanical light-guiding device not subject to vehicular or other vibration includes a first electrode layer, a second electrode layer, and a light-guiding layer between the first electrode layer and the second electrode layer. The first electrode layer is configured to receive a first voltage and reflect a laser light received. The second electrode layer is configured to receive a second voltage. A reflection angle of the laser light is controlled by deformation of the first electrode layer under the first voltage and the second voltage and changes therein, and the light-guiding layer controls a propagation direction of the laser light according to the respective magnitudes of the first voltage and the second voltage.

### FIELD

The present disclosure generally relates to optical technology, particularly relates to a light-guiding device and an optical radar.

### BACKGROUND

Optical radars include micro electromechanical system (MEMS) radars and mechanical radars. A micro electromechanical system (MEMS) radar can be used to in place of a mechanical radar when space is limited. The MEMS radar includes a laser source, a MEMS mirror, and receiving elements. The MEMS mirror includes a controlling circuit, a rocker arm, and a reflection element. The rocker arm moves the MEMS mirror to reflect laser light from the laser source at different angles to scan in different directions.

However, a size of the MEMS mirror needs to be reduced to be integrated into road vehicles. Moreover, when the MEMS mirror is rotating, the reflection element is only supported by the rocker arm. If the MEMS mirror is applied to road vehicles, vibrations when the vehicle is in motion may fracture the rocker arm.

### BRIEF DESCRIPTION OF DRAWINGS

FIG. 1 is a view of an optical radar in an embodiment of the present disclosure.

FIG. 2 is a view of a light-guiding device of the optical radar in FIG. 1.

FIG. 3 is a view showing a working principle of the optical radar in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

“Above” means one layer is located on top of another layer. In one example, it means one layer is situated directly on top of another layer. In another example, it means one layer is situated over the second layer with more layers or spacers in between.

When a feature or element is herein referred to as being “on” another feature or element, it can be directly on the other feature or element or intervening features and/or elements may also be present. It will also be understood that, when a feature or element is referred to as being “connected”, “attached” or “coupled” to another feature or element, it can be directly connected, attached or coupled to the other feature or element or an intervening features or elements may be present.

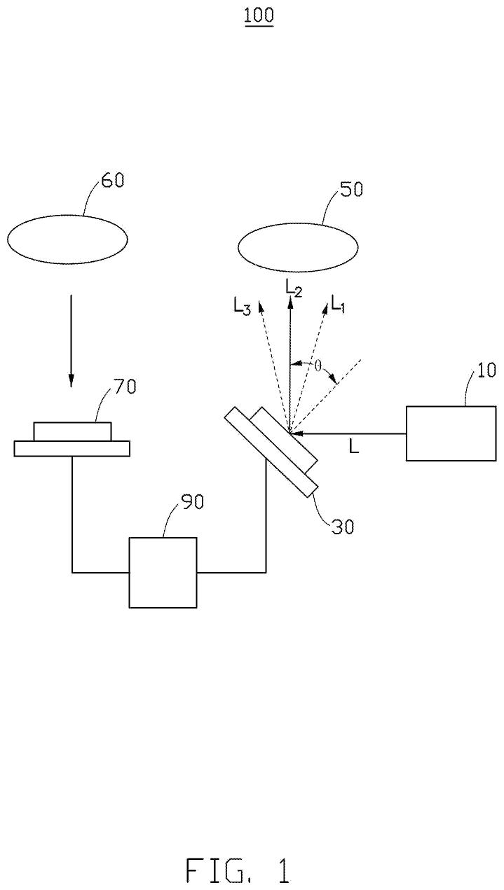

This embodiment of the present disclosure provides a solid-state optical radar. As shown in FIG. 1, the optical radar 100 includes a laser source 10, a light-guiding device 30, a transmitting device 50, a receiving device 60, an optical detector 70, and a controller 90.

The laser source 10 is used to emit laser light L. The light-guiding device 30 is used to reflect the laser light L from the laser source 10 and adjust a reflection angle θ of a laser light L₂ reflected by the light-guiding device 30. The laser light L₂ is used to scan at different directions and when the laser light hits an external object it will be reflected. The light detector 70 is used to receive the reflected light and generate a sensing signal. The controller 90 is used to control the light-guiding device 30 to adjust the reflection angle θ and analyze a direction and a distance between the external object and the optical radar 100 according to the sensing signal.

By controlling the light-guiding device 30 to adjust the reflection angle θ of the laser light L₂, the optical radar 100 can detect different positions within a scanning range of the laser light L₂. Information as to the location and direction of the external object is obtained by recording an angle of the reflected light, and the distance between the external object and the optical radar 100 is obtained by recording a time difference or phase difference between emission of the laser light L₂ and receipt of the reflected light.

In at least one embodiment, the laser light L includes infrared laser. The laser source 10 may be one of edge emitting laser (EEL), vertical cavity surface emitting laser (VCSEL), solid-state laser, and fiber laser.

In at least one embodiment, the laser light L may be pulsed laser. The laser light L is reflected at different angles by the light-guiding device 30 during each scanning cycle, so that the optical radar 100 can scan at a high frequency.

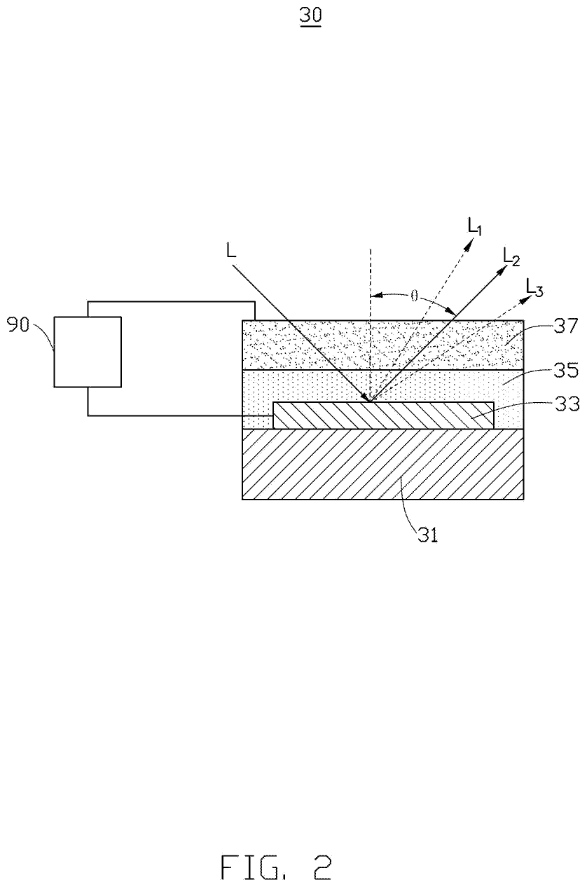

As shown in FIG. 2, the light-guiding device 30 includes a heat dissipation substrate 31, a first electrode layer 33, a light-guiding layer 35, and a second electrode layer 37. The first electrode layer 33 is used to receive a first voltage and reflect the laser light L. The second electrode layer 37 is at one side of the first electrode layer 33 and is configured to receive a second voltage. The light-guiding layer 35 is between the first electrode layer 33 and the second electrode layer 37 and is in direct contact with the first electrode layer 33. The light-guiding layer 35 is used to change direction of propagation (that is, the reflection angle θ) of the laser light L₂ according to the first voltage and the second voltage. The controller 90 is electrically connected to the first electrode layer 33 and the second electrode layer 37 to apply the first voltage and the second voltage, wherein a voltage difference between two sides of the light-guiding layer 35 exists. By changing values of the first voltage and the second voltage, the voltage difference is changed to change the propagation direction of the laser light L₂. In the present embodiment, a value of the voltage difference is within a range. The laser light L₁ is obtained when the voltage difference is a minimum value, and the laser light L₃ is obtained when the voltage difference is a maximum value. That is, the reflection angle θ changes in an area between the laser light L₃ and the laser light L₃, the area between the laser light L₁ and the laser light L₃ defines the scanning range of the optical radar 100.

In at least one embodiment, the light-guiding layer 35 includes electro-optical material and has a refractive index changing with the first voltage and the second voltage, thereby changing the propagation direction of the laser light L₂. The controller 90 is used to change the voltage difference between the two sides of the light-guiding layer 35 to change the refractive index of the light-guiding layer 35. As the refractive index changes, the reflection angle θ of the reflected laser light L₂ changes.

In at least one embodiment, the electro-optical material refers to material with electro-optical effect. The electro-optic effect refers to the refractive index of a material changes according to an applied electric field. The electro-optical effect includes Pockels effect and Kerr effect, wherein the refractive index being directly proportional to the power of the applied electric field intensity is defined as the Pockels effect or a linear electro-optical effect, and the refractive index being directly proportional to the quadratic power of the applied electric field intensity is defined as the Kerr effect, or as a secondary electro-optical effect. The electro-optic effect is very responsive to a change in the applied electrical signal, so a reflection angle θ of the laser light L₂ can be precisely and reliably changed by an electrical signal. Therefore, by using the electro-optical material as the material of the light-guiding layer 35, the optical radar 100 can effectively shorten detection time, which is conducive to improving a scanning frequency.

In at least one embodiment, the light-guiding layer 35 may include nonlinear electro-optical material. The larger the electro-optical coefficient of the nonlinear electro-optical materials, the greater will be the change of the refractive index per unit voltage. That is, the light-guiding layer 35 can achieve a large refractive index change with a small change in voltage, so that the laser light L₂ can have a large deflection angle. In addition, the greater the electro-optical coefficient of the electro-optic material the faster will the refractive index change for a given frequency of voltage change, and thus the faster the reflection angle θ of the laser light L₂ will change. Therefore, if the scanning range and the voltage change frequency remain constant, by increasing the electro-optic coefficient of the electro-optic material, the voltage required and applied to the two sides of the light-guiding layer 35 can be effectively reduced, and the scanning speed can be improved. That is, the optical radar 100 operates with a lower voltages and higher frequencies.

In another embodiment, the electro-optical material used in the light-guiding layer 35 may be a linear electro-optical material, or at least one of the nonlinear electro-optical material and the linear electro-optical material.

In at least one embodiment, the light-guiding layer 35 may include gallium arsenide (GaAs) or cadmium telluride (CdTe), or other crystal materials with electro-optical effect, such as potassium tantalum niobate (KTN), lithium niobate (LiNbO₃), lead zirconate titanate (PZT), or any one of various polymers with electro-optical characteristics. In addition, the light-guiding layer 35 may also include transparent conductive oxides, such as indium tin oxide, indium zinc oxide, aluminum zinc oxide, gallium zinc oxide, etc.

In at least one embodiment, the refractive index of the light-guiding layer 35 continuously changes with the first voltage and the second voltage being applied on both sides. That is, the reflection angle of the laser light L₂ increases with the continuous change of the refractive index θ. Thus, the laser light emitted by the optical radar 100 can be irradiated to any position within the scanning range.

In at least one embodiment, the first electrode layer 33 is made of metal, such as aluminum or gold. The first electrode layer 33 can achieve a better reflection efficiency since the first electrode layer 33 is made of metal, which reduces loss of the laser light L. In addition, metal has good heat dissipation, and less likely to be damaged by excessive temperature.

In at least one embodiment, since the first electrode layer 33 is made of metal, a surface of the first electrode layer 33 close to (directly attached to) the light-guiding layer 35 will deform according to the first voltage and the second voltage, wherein the reflection angle θ of the laser light L₂ will change due to deformation of the first electrode layer. The first electrode layer 33 made of metal can deform quickly according to the first voltage and the second voltage, so that the propagation direction of the laser light L₂ can be changed rapidly.

In at least one embodiment, the second electrode layer 37 is made of transparent conductive oxide. On the one hand, the second electrode layer 37 can be used as an electrode to apply the second voltage to the light-guiding layer 35. On the other hand, when the laser light L and the laser light L₂ pass through the second electrode layer 37, the second electrode layer 37 reduces a loss of the laser light L and the laser light L₂ since the second electrode layer 37 has a good light transmittance.

In at least one embodiment, the second electrode layer 37 is made of indium tin oxide (ITO), which reduces loss of the laser light and reduce a power consumption since ITO has low resistance and high light transmittance.

In at least one embodiment, the heat dissipation substrate 31 is at side of the first electrode layer 33 away from the second electrode layer 37 to dissipate heat of the first electrode layer 33. The heat dissipation substrate 31 may be a ceramic substrate, an epoxy resin copper clad laminate, a silicon containing substrate, etc.

In at least one embodiment, the first voltage applied to the first electrode layer 33 is an anode voltage, and the second voltage applied to the second electrode layer 37 is a cathode voltage. That is, the first electrode layer 33 is as an anode electrode, and the second electrode 37 is as a cathode electrode. The second electrode layer 37 forms charge carriers provided by intrinsic defects or impurities of the transparent oxide itself which are electrically conductive. Compared with the anode acting on the second electrode layer 37, the cathode acting on the second electrode layer 37 can provide electrons to the second electrode layer 37 faster, so that the light steering layer 35 can be controlled by the first voltage and the second voltage faster, and a precision and sensitivity of the refractive index change of the light-guiding layer 35 is improved.

In at least one embodiment, the transmitting device 50 is used to receive the laser light L₂ reflected by the light-guiding device 30 and guide the laser light L₂ outside the optical radar 100. The receiving device 60 is used to receive the reflected light from the external object A and guide the reflected light to the light detector 70.

In at least one embodiment, the transmitting device 50 may include at least one optical lens or lens group for reflecting the laser light L₂ from the light-guiding device 30, thereby expanding the scanning range of the optical radar 100. The receiving device 60 may include at least one optical lens or at least one optical lens group for expanding a receiving range, which receives the light reflected by the external object A in the scanning range and guides the reflection light to the light detector 70.

In at least one embodiment, the light detector 70 may include a plurality of photomultiplier tubes, thermoelectric detectors, or semiconductor photodetectors to generate electric signal (that is, the sensing signal) from the reflected light. The controller 90 may be a circuit, a chip, a computer, etc.

The working process of the optical radar 100 in this embodiment is described below in combination with the drawings.

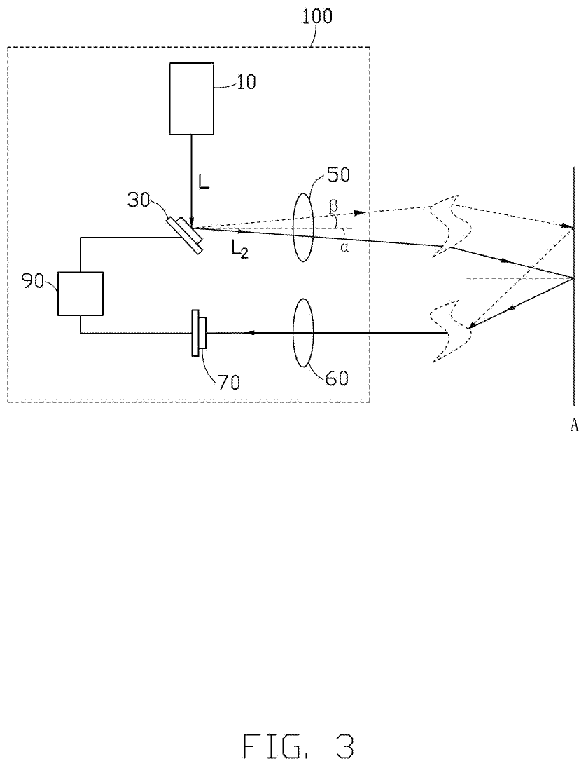

As shown in FIG. 2 and FIG. 3, the controller 90 applies the first voltage and the second voltage to the light-guiding device 30 to set the laser light L₂ at the reflection angle θ. The laser light L₂ exits from the transmitting device 50 with an exit angle α. The laser light L₂ is reflected by the external object A as the reflected light. The receiving device 60 receives the reflected light and guides same to the light detector 70. The light detector 70 generates the sensing signal accordingly so that the controller 90 can calculate a distance between the external object A and the optical radar 100 in a direction of the exit angle α according to the sensing signal.

Then, the controller 90 can change values of the first voltage and the second voltage applied to the light-guiding device 30, thereby changing the reflection angle θ of the laser light L₂, thus the transmitting device 50 transmits the laser light L₂ with an exit angle β, which can obtain a distance between the external object A and the optical radar 100 in a direction of the exit angle β.

By changing the values of the first voltage and the second voltage applied to the light-guiding device 30 several times, the laser light L₂ can be controlled to exit at different exit angles to detect different positions within the scanning range.

The optical radar 100 in the present embodiment includes the light-guiding device 30 including the light-guiding layer 35 including electro-optical material. Based on the refractive index of the electro-optic material changing with voltage, the optical radar 100 can change the exit angle of the laser light L₂ emitted from the transmitting device 50 without mechanical assistance, which avoids changing an optical path of the laser light by a galvanometer and reduces a size of the optical radar 100. Moreover, when the optical radar 100 is applied to road vehicles, damage to hardware caused by vehicle vibration can also be avoided by replacing the galvanometer with the light-guiding device 30, which is conducive to improve a service life of the optical radar 100. In addition, the light-guiding device 30 of the present embodiment includes the first electrode layer 33 made of metal. The surface of the first electrode layer 33 in contact with the light-guiding layer 35 can deform rapidly according to an electric field caused by the first electrode layer 33 and the second electrode layer 37. When the first electrode layer 33 is deformed, the propagation direction of the reflected laser L₂ will change accordingly. Therefore, compared with liquid crystal and galvanometer, the light-guiding device 30 of the present embodiment improves a rate of change of the exit angle of the laser L₂, thereby improving a scanning efficiency of the optical radar 100.

The embodiments shown and described above are only examples. Many details are often found in the art such as the other features of a light-emitting assembly and a display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A light-guiding device comprising:
a first electrode layer configured to receive a first voltage;
a second electrode layer configured to receive a second voltage; and
a light-guiding layer between the first electrode layer and the second electrode layer;
wherein the first electrode layer is configured to receive and reflect laser light, a reflection angle of the laser light reflected by the first electrode layer is controlled by deformation of the first electrode layer when the first voltage and the second voltage are applied, and the light-guiding layer is configured to control a propagation direction of the laser light according to the first voltage and the second voltage.

2. The light-guiding device of claim 1, wherein a refractive index of the light-guiding layer changes as the difference between the first and the second voltages changes, thereby controlling the propagation direction of the laser light.

3. The light-guiding device of claim 1, wherein the light-guiding layer comprises electro-optic material, and the refractive index changes continuously as the difference between the first and the second voltages changes.

4. The light-guiding device of claim 3, wherein the light-guiding layer comprises at least one of a nonlinear electro-optic material and a linear electro-optic material.

5. The light-guiding device of claim 1, wherein the first electrode layer is made of metal.

6. The light-guiding device of claim 1, wherein the second electrode layer is made of transparent conductive oxide.

7. The light-guiding device of claim 1, wherein the light-guiding layer comprises a heat dissipation substrate at a side of the first electrode layer away from the second electrode layer, and the heat dissipation substrate is configured to dissipate heat generated by the first electrode layer.

8. The light-guiding device of claim 1, wherein the first electrode layer is an anode electrode, and the second electrode layer is a cathode electrode.

9. A light-guiding device comprising:
a first electrode layer configured to receive a first voltage;
a second electrode layer configured to receive a second voltage; and
a light-guiding layer between the first electrode layer and the second electrode layer;
wherein the first electrode layer is configured to receive and reflect a laser light, the first electrode layer and the light-guiding are configured to control an exit angle of the laser light reflected by the first electrode layer according to the first voltage and the second voltage.

10. An optical radar comprising:
a laser source configured to emit a laser light;
a light-guiding device comprising:
a first electrode layer configured to receive a first voltage;
a second electrode layer configured to receive a second voltage; and
a light-guiding layer between the first electrode layer and the second electrode layer;
wherein the first electrode layer is configured to receive and reflect a laser light, the first electrode layer and the light-guiding are configured to guide the laser light to an external object, and the first electrode layer and the light-guiding are configured to control an exit angle of the laser light according to the first voltage and the second voltage;
a light detector configured to receive a reflected light and generate a sensing signal according to the reflected light, the reflected light being reflected by the external object according to the laser light; and
a controller electrically connected to the first electrode layer, the second electrode layer, and the light detector, the controller configured to control the first voltage and the second voltage to control the exit angle, and generate a direction and distance of the external object according to the sensing signal.

11. The optical radar of claim 10, wherein a reflection angle of the laser light is controlled by the first electrode layer according to the first voltage and the second voltage, and the light-guiding layer is configured to control a propagation direction of the laser light according to the first voltage and the second voltage

12. The optical radar of claim 11 further comprising:
an emitting device configured to receive the laser light from the light-guiding device and emit the laser light out the optical radar; and
a receiving device configured to receive the reflected light and guide the reflected light to the light detector.

13. The optical radar of claim 12, wherein the emitting device comprises at least one lens and the receiving device comprises at least one lens.

14. The optical radar of claim 11, wherein a refractive index of the light-guiding layer changes with the first voltage and the second voltage to change the propagation direction of the laser light.

15. The optical radar of claim 11, wherein the light-guiding layer comprises electro-optic material, and the refractive index changes continuously with the first voltage and the second voltage.

16. The optical radar of claim 15, wherein the light-guiding layer comprises at least one of a nonlinear electro-optic material and a linear electro-optic material.

17. The optical radar of claim 11, wherein the first electrode layer is made of metal.

18. The optical radar of claim 11, wherein the second electrode layer is made of transparent conductive oxide.

19. The optical radar of claim 11, wherein the light-guiding layer comprises a heat dissipation substrate at a side of the first electrode layer away from the second electrode layer, and the heat dissipation substrate is configured to dissipate heat for the first electrode layer.

20. The optical radar of claim 11, wherein the first voltage is an anode voltage, and the second voltage is a cathode voltage.
